(19) United States
(12) Patent Application Publication
(10) Pub. No.: US 2006/0190528 A1
(43) Pub. Date: Aug. 24, 2006

(54) Apparatus and method for distributing signals

(76) Inventors: Michael Anthony Pugel, Noblesville, IN (US); Douglas Edward Lankford, Carmel, IN (US); John Joseph Curtis, Noblesville, IN (US); Keith Reynolds Wehmeyer, Fishers, IN (US); Mike Arthur Derrenberger, Fishers, IN (US); Terry Wayne Lockridge, Dayton, OH (US); Andrew Eric Bowyer, Indianapolis, IN (US)

Correspondence Address: THOMSON LICENSING INC., PATENT OPERATIONS, PO BOX 5312, PRINCETON, NJ, 08543-5312, US

(21) Appl. No.: 10/549,253

(22) PCT Filed: Mar. 9, 2004
(86) PCT No.: PCT/US04/07152

§ 371 Date: Sep. 12, 2005

Related U.S. Application Data
(60) Provisional application No. 60/453,763, filed on Mar. 11, 2003.
(60) Provisional application No. 60/453,491, filed on Mar. 11, 2003.

(51) Int. Cl. G06F 15/16

(52) U.S. Cl. 709/203

(57) ABSTRACT

A server apparatus is capable of distributing audio, video, and/or data signals in a household and/or business dwelling using the existing coaxial cable infrastructure. According to an exemplary embodiment, the server apparatus includes a receiving element operative to receive signals from a broadcast source. First processing elements generate first analog signals responsive to the received signals. Second processing elements generate second analog signals responsive to the received signals. The first analog signals are provided to a first dent device via a coaxial cable connecting the server apparatus and the first client device. The second analog signals are provided to a second client device via the coaxial cable connecting the server apparatus and the second client device.

### CROSS REFERENCE TO RELATED APPLICATION

This application claims priority to and all benefits accruing from two provisional applications filed in the United States Patent and Trademark Office on Mar. 11, 2003, and having respectively assigned Ser. Nos. 60/453,491 and 60/453,763.

### BACKGROUND OF THE INVENTION

1. Field of the Invention

The present invention generally relates to the distribution of signals such as audio, video and/or data signals, and more particularly, to an apparatus and method capable of distributing such signals in a household and/or business dwelling using the existing coaxial cable infrastructure.

2. Background Information

In a satellite broadcast system, a satellite receives signals representing audio, video, and/or data information from an earth-based transmitter. The satellite amplifies and rebroadcasts these signals to a plurality of receivers, located at the dwellings of consumers, via transponders operating at specified frequencies and having given bandwidths. Such a system includes an uplink transmitting portion (i.e., earth to satellite), an earth-orbiting satellite receiving and transmitting portion, and a downlink portion (i.e., satellite to earth) including one or more receivers located at the dwellings of consumers.

For dwellings that receive signals via systems such as a satellite broadcast system, the distribution of received signals in the dwelling can be a difficult proposition. For example, many existing dwellings are equipped with coaxial cable such as RG-59 type coaxial cable, which is not readily conducive for distributing certain signals such as satellite broadcast signals. One reason coaxial cable such as RG-59 is not used to distribute such signals in a dwelling is that the coaxial cable may already be used for distributing cable broadcast signals. Accordingly, it may be difficult for signals such as satellite broadcast signals to co-exist with cable broadcast signals on the coaxial cable given its limited bandwidth. Another reason that coaxial cable such as RG-59 is not used to distribute certain signals in a dwelling is that the coaxial cable may use a portion of the frequency spectrum that is different than the frequencies occupied by the signals to be distributed. For example, signals such as satellite broadcast signals may occupy a portion of the frequency spectrum (e.g., greater than 1 GHz) which is higher than the signal frequencies that can be readily distributed over coaxial cable such as RG-59 and its associated signal splitters and/or repeaters (e.g., less than 860 MHz).

Heretofore, the issue of distributing signals such as satellite broadcast signals in a dwelling using the existing coaxial cable infrastructure (e.g., RG-59) has not been adequately addressed. While certain technologies (e.g., IEEE 1394) may be used for signal distribution within a dwelling, such technologies typically require a dwelling to be re-wired, which may be cost-prohibitive for most consumers. Moreover, existing wireless technologies may not be suitable for distributing certain types of signals, such as video signals, within a dwelling.

Accordingly, there is a need for an apparatus and method, which avoids the foregoing problems, and thereby enables audio, video, and/or data signals to be distributed in a household and/or business dwelling using the existing coaxial cable infrastructure.

### SUMMARY OF THE INVENTION

In accordance with an aspect of the present invention, a server apparatus is disclosed. According to an exemplary embodiment, the server apparatus comprises receiving means for receiving signals from a broadcast source. First processing means generate first analog signals responsive to the received signals. Second processing means generate second analog signals responsive to the received signals, wherein the second analog signals have a different encoding than the first analog signals. The first analog signals are provided to a first client device via a coaxial cable connecting the server apparatus and the first client device. The second analog signals are provided to a second client device via the coaxial cable connecting the server apparatus and the second client device.

In accordance with another aspect of the present invention, a method for distributing signals from a server apparatus to a first client device and a second client device is disclosed. According to an exemplary embodiment, the method comprises steps of receiving signals from a broadcast source, generating first analog signals responsive to the received signals, generating second analog signals responsive to the received signals, providing the first analog signals to the first client device via a coaxial cable connecting the server apparatus to the first client device, and providing the second analog signals to the second client device via the coaxial cable connecting the server apparatus to the second client device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram of an exemplary environment suitable for implementing the present invention;

FIG. 2 is a block diagram of the server apparatus of FIG. 1 according to an exemplary embodiment of the present invention;

FIG. 3 is a block diagram of one of the second client devices of FIG. 1 according to an exemplary embodiment of the present invention;

FIG. 4 is a flowchart illustrating steps according to an exemplary embodiment of the present invention;

FIG. 5 is a flowchart illustrating further details regarding one of the steps of FIG. 4 according to an exemplary embodiment of the present invention; and

FIG. 6 is a flowchart illustrating further details regarding another one of the steps of FIG. 4 according to an exemplary embodiment of the present invention.

The exemplifications set out herein illustrate preferred embodiments of the invention, and such exemplifications are not to be construed as limiting the scope of the invention in any manner.

DESCRIPTION OF THE PREFERRED EMBODIMENTS

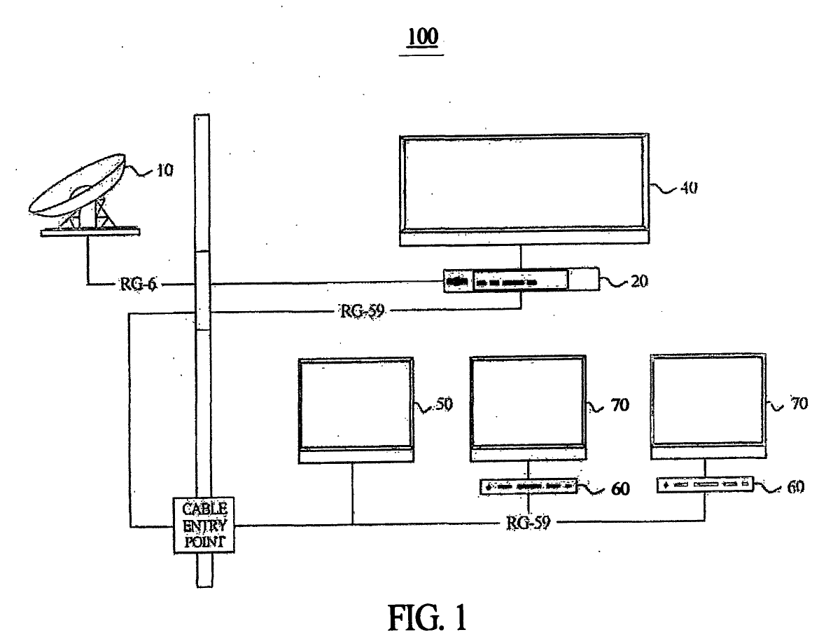

Referring now to the drawings, and more particularly to FIG. 1, a diagram of an exemplary environment 100 suitable for implementing the present invention is shown. In FIG. 1, environment 100 comprises a signal receiving element 10, a server apparatus 20 having an associated local output device 40, a first client device 50, and one or more second client devices 60 each having an associated local output device 70. According to an exemplary embodiment, signal receiving element 10 is operatively coupled to server apparatus 20 via a coaxial cable connection comprised of RG-6 type coaxial cable, and server apparatus 20 is operatively coupled to each of the client devices 50 and 60 via a coaxial cable connection comprised of RG-59 type coaxial cable. Other transmission media such as other types of coaxial cable, optical fibers, and air may also be used according to the present invention. Although not expressly shown in FIG. 1, environment 100 may also include elements such as signal splitters and/or repeaters. Environment 100 may for example represent a signal distribution network within a given household and/or business dwelling.

Signal receiving element 10 is operative to receive signals including audio, video, and/or data signals from one or more signal sources, such as a satellite broadcast system and/or other systems such as a digital terrestrial broadcast system. According to an exemplary embodiment, signal receiving element 10 is embodied as an antenna such as a satellite receiving dish, but may also be embodied as any type of signal receiving element such as an input terminal and/or other element.

Server apparatus 20 is operative to receive signals including audio, video, and/or data signals from signal receiving element 10, process the received signals to generate first and second analog signals where the first analog signals have a different encoding than the second analog signals, distribute the first analog signals to local output device 40 and/or first client device 50, and distribute the second analog signals to one or more second client devices 60. According to an exemplary embodiment, local output device 40 is operative to provide aural and/or visual outputs corresponding to first analog signals provided from server apparatus 20, and may be embodied as an analog and/or digital device such as for example a standard-definition (SD) television signal receiver, and/or a high-definition (HD) television signal receiver.

According to an exemplary embodiment, first client device 50 is operative to receive and process first analog signals provided from server apparatus 20 to thereby enable corresponding aural and/or visual outputs. First client device 50 may be embodied as an analog and/or digital device such as a SD and/or HD television signal receiver. Although only one first client device 50 is shown in FIG. 1 for purposes of example, a plurality of such first client devices 50 may be connected in environment 100.

Also, according to an exemplary embodiment, each second client device 60 is operative to receive and process second analog signals provided from server apparatus 20 to thereby enable corresponding aural and/or visual outputs via local output device 70. Each local output device 70 may be embodied as an analog and/or digital device such as a SD and/or HD television signal receiver. Further exemplary details regarding second client devices 60 will be provided later herein. As referred to herein, a device may be considered an “analog device” if it is capable of receiving and processing signals having an analog type of encoding or modulation (e.g., NTSC, PAL, SECAM, etc.), while a device may be considered a “digital device” if it is capable of receiving and processing signals having a digital type of encoding or modulation (e.g., QPSK, QAM, VSB, etc.).

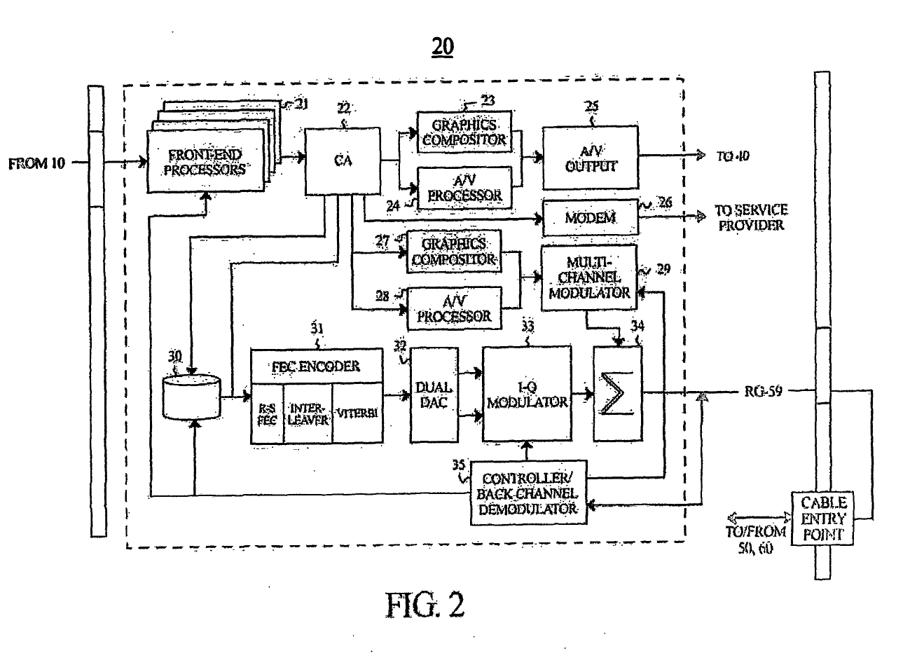

Referring to FIG. 2, a block diagram of server apparatus 20 of FIG. 1 according to an exemplary embodiment of the present invention is shown. In FIG. 2, server apparatus 20 comprises front-end processing means such as front-end processors 21, conditional access (CA) means such as CA module 22, first graphics compositing means such as graphics compositor 23, first audio/video (A/V) processing means such as A/V processor 24, A/V output means such as A/V output 25, modulating/demodulating means such as modem 26, second graphics compositing means such as graphics compositor 27, second A/V processing means such as A/V processor 28, first modulating means such as multi-channel modulator 29, memory means such as memory 30, encoding means such as forward error correction (FEC) encoder 31, digital-to-analog converting means such as dual digital-to-analog converter (DAC) 32, second modulating means such as I-Q modulator 33, signal combining means such as signal combiner 34, and controlling/demodulating means such as controller/back channel demodulator 35. The foregoing elements of FIG. 2 may be embodied using integrated circuits (ICs), and any given element may for example be included on one or more ICs. For clarity of description, certain conventional elements associated with server apparatus 20 such as certain control signals, power signals and/or other elements may not be shown in FIG. 2.

Front-end processors 21 are operative to perform various front-end processing functions of server apparatus 20. According to an exemplary embodiment, front-end processors 21 are each operative to perform processing functions including channel tuning, analog-to-digital (A/D) conversion, demodulation, FEC decoding, and de-multiplexing functions. According to an exemplary embodiment, the channel tuning function of each front-end processor 21 may convert satellite broadcast signals from a relatively high frequency band (e.g., greater than 1 GHz) to baseband signals. As referred to herein, the term “baseband” may refer to signals, which are at, or near, a baseband level. The tuned baseband signals are converted to digital signals, which are demodulated to generate demodulated digital signals. According to an exemplary embodiment, each front-end processor 21 may be operative to demodulate various types of signals such as Quadrature Amplitude Modulated (QAM) signals, Phase Shift Keyed (PSI<, e.g., QPSK) signals, and/or signals having other types of modulation. The FEC decoding function is applied to the demodulated digital signals to thereby generate error corrected digital signals. According to an exemplary embodiment, the FEC decoding function of each front-end processor 21 may include Reed-Solomon (R-S) FEC, de-interleaving, Viterbi and/or other functions. The error corrected digital signals may include a plurality of time-division multiplexed broadcast programs, and are de-multiplexed into one or more digital transport streams. For purposes of example and explanation, server apparatus 20 of FIG. 2 includes four front-end processors 21 (i.e., one for local output device 40, and one for each client device 50 and 60). In practice, however, the number of front-end processors 21 may be a matter of design choice. For example, the number of front-end processors 21 may vary depending upon the number of coaxially connected client devices 50 and 60 serviced by server apparatus 20. Accordingly, there may be “N+1” front-end processors 21 for “N” client devices 50 and 60, where “N” is an integer.

CA module 22 is operative to perform a CA function of server apparatus 20 by decrypting the digital transport streams provided from front-end processors 21 to thereby generate decrypted digital transport streams. According to an exemplary embodiment, CA module 22 may include a smart card and/or other elements, which enable the CA function.

Graphics compositor 23 is operative to perform graphics compositing functions of server apparatus 20, which enable graphical displays via local output device 40. According to an exemplary embodiment, graphics compositor 27 generates analog and/or digital signals which represent graphical displays such as user interfaces (UIs) which allow users to interact with server apparatus 20, first client device 50, and/or second client devices 60.

A/V processor 24 is operative to perform various A/V processing functions of server apparatus 20, which enable aural and/or visual outputs via local output device 40. According to an exemplary embodiment, A/V processor 24 is operative to process the decrypted digital transport streams provided from CA module 22 by performing functions including Motion Picture Expert Group (MPEG) decoding, National Television Standards Committee (NTSC) or other type of encoding, and digital-to-analog (D/A) conversion functions to thereby generate analog baseband signals. In this manner, the decrypted digital transport stream provided from CA module 22 may be MPEG decoded to generate decoded signals. The decoded signals may then be encoded as NTSC signals or other types of signals (e.g., PAL, SECAM, VSB, QAM, etc.), and converted to analog signals. In the event local output device 40 is a digital device such as a digital television signal receiver, the aforementioned encoding and/or D/A functions of A/V processor 24 may be bypassed.

A/V output 25 is operative to perform an A/V output function of server apparatus 20 by enabling output of the analog and/or digital signals provided from graphics compositor 23 and/or A/V processor 24 to local output device 40. According to an exemplary embodiment, A/V output 25 may be embodied as any type of A/V output means such as any type of wired and/or wireless output terminal.

Modem 26 is operative to provide signals representing information such as billing, pay-per-view, and/or other information to a service provider. According to an exemplary embodiment, modem 26 may be coupled to a transmission medium such as a telephone line, and may be programmed to provide such information to the service provider in accordance with a predetermined schedule (e.g., every other Tuesday at 2:00 am, etc.).

Graphics compositor 27 is operative to perform graphics compositing functions of server apparatus 20, which enable graphical displays via first client device 50. According to an exemplary embodiment, graphics compositor 27 generates analog signals, which represent graphical displays such as UIs, which allow users to interact with server apparatus 20, first client device 50, and/or second client devices 60.

A/V processor 28 is operative to perform various A/V processing functions of server apparatus 20, which enable aural and/or visual outputs via first client device 50. According to an exemplary embodiment, A/V processor 28 is operative to process the one or more decrypted digital transport streams provided from CA module 22 using the same functions as A/V processor 24, including the MPEG decoding, NTSC or other encoding, and D/A conversion functions previously described herein to thereby generate analog baseband signals.

Multi-channel modulator 29 is operative to modulate the analog signals provided from graphics compositors 27 and/or A/V processors 28 and to thereby generate first analog signals which may be provided to first client device 50 via the coaxial cable connecting server apparatus 20 and first and second client devices 50 and 60. Multi-channel modulator 29 may perform functions such as frequency upconversion, quadrature combining, filtering and/or other functions. According to an exemplary embodiment, multi-channel modulator 29 modulates the analog signals responsive to one or more control signals provided from controller 35. Such control signals cause multi-channel modulator 29 to modulate the analog signals to one or more available frequency bands on the coaxial cable which may be used to provide the first analog signals from server apparatus 20 to first client device 50. According to an exemplary embodiment, multi-channel modulator 29 modulates the analog signals to frequency bands, which are less than 1 GHz.

Memory 30 is operative to record digital data including the decrypted digital transport streams provided from CA module 22. According to an exemplary embodiment, the digital data recorded in memory 30 may be accessed by any of the first and second client devices 50 and 60 via the coaxial cable connecting server apparatus 20 and first and second client devices 50 and 60. For example, first and second client devices 50 and 60 may be provided with an electronic program guide (EPG) or other directory which describes (e.g., by program name, time of recording, etc.) the digital data recorded in memory 30. Server apparatus 20 may distribute this EPG or directory to first and second client devices 50 and 60 via the coaxial cable on a periodic basis to apprise users of the digital data currently stored in memory 30. In this manner, users may interact with the EPG or directory to select digital data to be retrieved and distributed to first and second client devices 50 and 60 via the coaxial cable. Memory 30 may be embodied as any type of suitable storage medium such as a hard disk drive (HDD), digital versatile disk (DVD), and/or other data storage medium.

FEC encoder 31 is operative to encode the digital data provided from CA module 22 and memory 30 with error correction data to thereby generate encoded digital signals. According to an exemplary embodiment, FEC encoder 31 is operative to encode the decrypted digital transport streams by performing functions including R-S FEC, data interleaving, Viterbi and/or other functions.

Dual DAC 32 is operative to convert the encoded digital signals provided from FEC encoder 31 to analog baseband signals. According to an exemplary embodiment, dual DAC 32 generates the analog baseband signals as separate I (i.e., in-phase) and Q (i.e., quadrature) signals.

I-Q modulator 33 is operative to modulate the I and Q analog baseband signals provided from dual DAC 32 to thereby generate second analog signals which may be provided to one or more second client devices 60 via the coaxial cable connecting server apparatus 20 and first and second client devices 50 and 60. I-Q modulator 33 may perform functions such as frequency upconversion, quadrature combining, filtering, and/or other functions. According to an exemplary embodiment, I-Q modulator 33 modulates the analog baseband signals responsive to one or more control signals provided from controller 35. Such control signals cause I-Q modulator 33 to modulate the analog baseband signals to one or more available frequency bands on the coaxial cable which may be used to provide the second analog signals from server apparatus 20 to one or more second client devices 60. According to an exemplary embodiment, I-Q modulator 33 modulates the analog baseband signals to radio frequency (RF) bands, which are less than 1 GHz.

According to an alternative embodiment, dual DAC 32 and I-Q modulator 33 may be replaced by a single DAC and an RF modulator (not shown in FIG. 2). With this alternative embodiment, an I-Q modulation function may be incorporated into FEC encoder 31 which would produce baseband encoded digital signals. The single DAC would convert the baseband encoded digital signals to analog signals. The RF modulator would then RF modulate the analog signals to one or more available frequency bands on the coaxial cable for delivery to one or more second client devices 60.

Signal combiner 34 is operative to combine the first and second analog signals provided from multi-channel modulator 29 and I-Q modulator 33, and output the first and second analog signals to first and second client devices 50 and 60, respectively. Although signal combiner 34 is expressly shown in FIG. 2 for purposes of example and explanation, its function could be combined into multi-channel modulator 29 and I-Q modulator 33.

Controller/back channel demodulator 35 is operative to perform various functions of server apparatus 20 including data retrieval functions, control functions and back channel demodulation functions. According to an exemplary embodiment, controller 35 performs a data retrieval function by generating one or more control signals, which enable digital data to be retrieved from memory 30. Also, according to an exemplary embodiment, controller 35 is operative to detect one or more available frequency bands on the coaxial cable, which may be used to provide the first and second analog signals from server apparatus 20 to first client device 50 and second client devices 60, respectively. Based on this detection, controller 35 generates one or more control signals, which control multi-channel modulator 29 and I-Q modulator 33, as previously described herein.

According to an exemplary embodiment, controller 35 dynamically scans a plurality of frequency bands on the coaxial cable to thereby detect the one or more available frequency bands. The controller 31 may detect an available frequency band by measuring the signal power in that frequency band. If the signal power of a frequency band is below a threshold, the controller 31 determines that the frequency band is available. According to another exemplary embodiment, controller 35 may detect the one or more available frequency bands on the coaxial cable based on a user input. For example, a user may interact with server apparatus 20 via an on-screen UI provided via local output device 40 and/or one or more of first and second client devices 50 and 60 which enables the user to select one or more frequency bands on the coaxial cable to be used for signal transmission between server apparatus 20 and first and second client devices 50 and 60. In this manner, the user may cause certain frequency bands on the coaxial cable to be dedicated (i.e., “notched out”) for signal transmission between server apparatus 20 and first and second client devices 50 and 60.

Also, according to an exemplary embodiment, back channel demodulator 35 is operative to demodulate request signals provided from first and second client devices 50 and 60 via the coaxial cable, which may be used as a back channel. Such request signals may control various functions of server apparatus 20, such as the aforementioned data retrieval function and a channel tuning function. For example, a demodulated request signal generated by back channel demodulator 35 may cause controller 35 to generate a corresponding control signal, which enables certain digital data (e.g., a broadcast program) to be stored and/or retrieved from memory 30. A demodulated request signal generated by back channel demodulator 35 may also cause controller 35 to generate a corresponding control signal, which controls the channel tuning function via front-end processors 21.

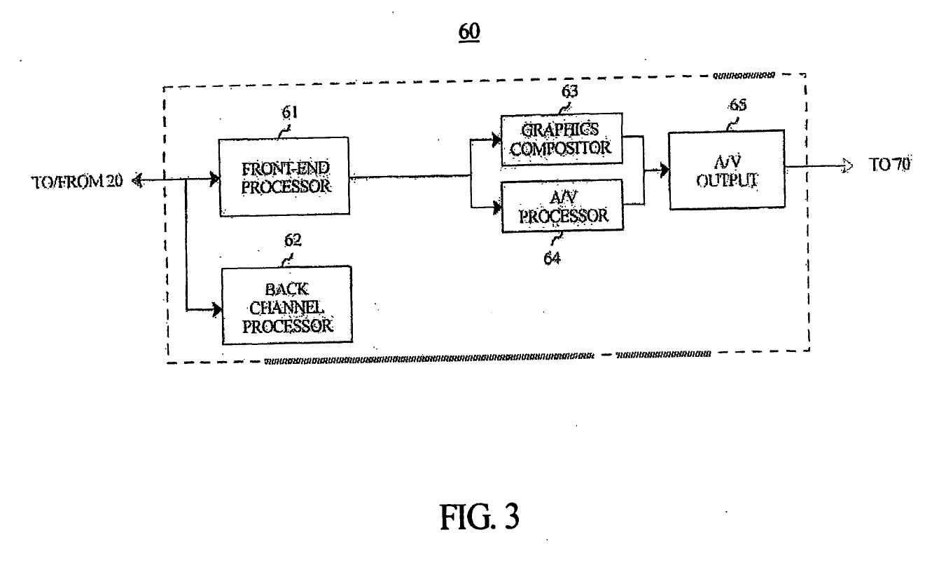

Referring to FIG. 3, a block diagram of one of the second client devices 60 of FIG. 1 according to an exemplary embodiment of the present invention is shown. In FIG. 3, second client device 60 comprises front-end processing means such as front-end processor 61, back channel processing means such as back channel processor 62, graphics compositing means such as graphics compositor 63, A/V processing means such as A/V processor 64, and A/V output means such as A/V output 65. The foregoing elements of FIG. 3 may be embodied using ICs, and any given element may for example be included on one or more ICs. For clarity of description, certain conventional elements associated with second client device 60 such as certain control signals, power signals and/or other elements may not be shown in FIG. 3.

Front-end processor 61 is operative to perform various front-end processing functions of second client device 60. According to an exemplary embodiment, front-end processor 61 is operative to perform processing functions including channel tuning, A/D conversion, demodulation, FEC decoding, and de-multiplexing functions. According to an exemplary embodiment, the channel tuning function of front-end processor 61 converts the second analog signals provided via the coaxial cable from server apparatus 20 to baseband signals. The tuned baseband signals are converted to digital signals, which are demodulated to generate demodulated digital signals. According to an exemplary embodiment, front-end processor 61 may be operative to demodulate various types of signals such as QAM signals, QPSK signals, and/or signals having other types of modulation. The FEC decoding function is applied to the demodulated digital signals to thereby generate error corrected digital signals. According to an exemplary embodiment, the FEC decoding function of front-end processor 61 may include R-S FEC, de-interleaving, Viterbi and/or other functions. The error corrected digital signals may include a plurality of time-division multiplexed broadcast programs, and are de-multiplexed into one or more digital transport streams.

Back channel processor 62 is operative to perform various back channel processing functions of second client device 60. According to an exemplary embodiment, back channel processor 62 is operative to generate request signals responsive to user inputs to second client device 60, and such request signals may be used to control server apparatus 20. For example, back channel processor 62 may generate a request signal responsive to a user input which requests that server apparatus 20 record certain data (e.g., a particular broadcast program) in memory 30. As another example, back channel processor 62 may generate a request signal responsive to a user input which requests that certain recorded data (e.g., a recorded broadcast program) in memory 30 of server apparatus 20 be retrieved and provided to second client device 60 via the coaxial cable connecting server apparatus 20 and first and second client devices 50 and 60. As yet another example, back channel processor 62 may generate a request signal responsive to a user input which requests that server apparatus 20 tune to a particular channel and provide signals from that channel to second client device 60 via the coaxial cable connecting server apparatus 20 and first and second client devices 50 and 60. A given request signal may include various types of information, which may be matter of design choice. For example, request signals may include information that identifies data or signals based on corresponding digital transport stream(s). In the event that server apparatus 20 is receiving signals from a satellite broadcast system, the request signal may also include information indicating a particular transponder, which provides the digital transport stream(s). Other types of information may also be included in the request signal.

Also, according to an exemplary embodiment, back channel processor 62 is operative to detect one or more available frequency bands on the coaxial cable, which may be used to provide the request signals from second client device 60 to server apparatus 20. According to an exemplary embodiment, back channel processor 62 may detect the one or more available frequency bands on the coaxial cable in the same manner as controller 35 of server apparatus 20. In particular, back channel processor 62 may dynamically scan a plurality of frequency bands on the coaxial cable to thereby detect the one or more available frequency bands, and/or may detect the one or more available frequency bands on the coaxial cable based on a user input, which selects the one or more available frequency bands.

According to a first exemplary embodiment, back channel processor 62 may also control the channel tuning function of front-end processor 61. For example, back channel processor 62 may include in a request to gateway apparatus 20 one of the available frequency bands it has dynamically detected or a frequency band selected by a user, and signal front-end processor 61 to tune that available frequency band or the frequency band selected by the user.

According to a second exemplary embodiment, back channel processor 62 may include all the available frequency bands in a request, and gateway apparatus 20 selects one of the available frequency bands to provide broadcast signals from a channel selected by a user. In the second exemplary embodiment, back channel processor 62 may dynamically scan a plurality of frequency bands on the coaxial cable after a request signal is provided to gateway apparatus 20 in order to detect a desired digital transport stream provided from gateway apparatus 20. According to this second exemplary embodiment, back channel processor 62 may process signals from the plurality of frequency bands to thereby detect a desired digital transport stream. For example, back channel processor 62 may detect program identification information in the signals from the plurality of frequency bands to thereby detect a desired digital transport stream. Once a desired digital transport stream is detected, back channel processor 62 may provide a control signal to front-end processor 61, which causes the front-end processor 61 to tune the particular frequency band on the coaxial cable that provides the desired digital transport stream.

In a third exemplary embodiment, back channel processor 62 does not include a frequency band in a request and gateway apparatus must detect an available frequency band to provide broadcast signals from a channel selected by the user. In this third exemplary embodiment, back channel should detect a desired digital transport stream and cause front-end processor 61 to tune the particular frequency band on the coaxial cable that provides the desired digital transport stream, as discussed above with respect to the second exemplary embodiment.

Graphics compositor 63 is operative to perform graphics compositing functions of second client device 60, which enable graphical displays via local output device 70. According to an exemplary embodiment, graphics compositor 63 generates analog and/or digital signals which represent graphical displays such as Uls which allow users to interact with server apparatus 20, first client device 50 and/or second client devices 60.

A/V processor 64 is operative to perform various A/V processing functions of second client device 60. According to an exemplary embodiment, A/V processor 64 is operative to perform functions including MPEG decoding, NTSC or other type of encoding, and D/A conversion functions. In this manner, the digital transport stream provided from front-end processor 61 may be MPEG decoded to generate decoded signals. The decoded signals may then be encoded as NTSC signals or other types of signals (e.g., PAL, SECAM, VSB, QAM, etc.), and converted to analog signals. In the event local output device 70 is a digital device such as a digital television signal receiver, the aforementioned encoding and/or D/A functions of A/V processor 64 may be bypassed.

A/V output 65 is operative to perform an A/V output function of second client device 60 by enabling output of the analog and/or digital signals provided from graphics compositor 63 and/or A/V processor 64 to local output device 70. According to an exemplary embodiment, A/V output 65 may be embodied as any type of A/V output means such as any type of wired and/or wireless output terminal.

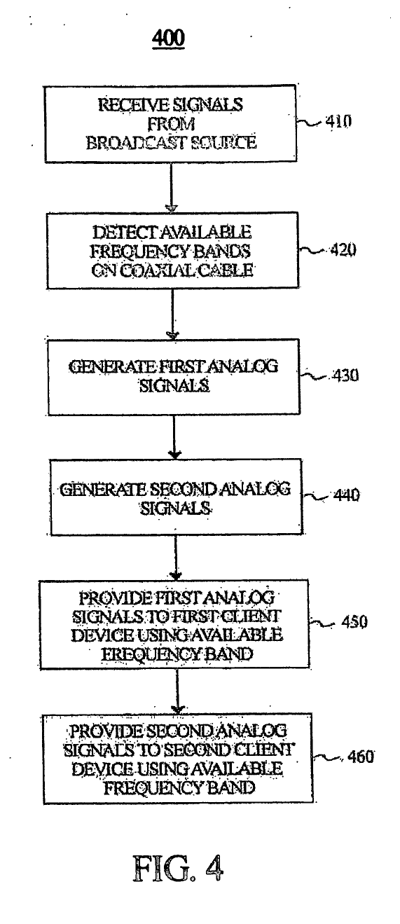

To facilitate a better understanding of the inventive concepts of the present invention, an example will now be provided. Referring to FIG. 4, a flowchart 400 illustrating steps according to an exemplary embodiment of the present invention is shown. For purposes of example and explanation, the steps of FIG. 4 will also be described with reference to the previously described elements of environment 100 of FIG. 1. The steps of FIG. 4 are merely exemplary, and are not intended to limit the present invention in any manner.

At step 410, server apparatus 20 receives signals provided from a broadcast source. According to an exemplary embodiment, server apparatus 20 receives via signal receiving element 10 signals such as audio, video, and/or data signals from one or more signal sources, such as a satellite broadcast system and/or other systems such as a digital terrestrial broadcast system.

At step 420, server apparatus 20 detects one or more available frequency bands on the coaxial cable connecting it to first and second client devices 50 and 60. As previously indicated herein, controller 35 may dynamically scan a plurality of frequency bands on the coaxial cable to detect the one or more available frequency bands at step 420, and/or may detect the one or more available frequency bands based on a user input which selects the available frequency bands.

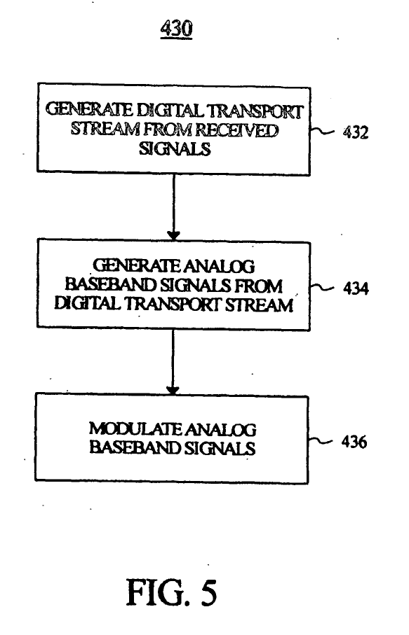

At step 430, server apparatus 20 generates first analog signals. Further details regarding step 430 of FIG. 4 according to an exemplary embodiment of the present invention are provided in FIG. 5. The details of FIG. 5 are merely exemplary, and are not intended to limit the present invention in any manner. As indicated in FIG. 5, step 430 of FIG. 4 includes sub-steps 432, 434 and 436.

At step 432, server apparatus 20 generates a digital transport stream from the received broadcast signals. According to an exemplary embodiment, the digital transport stream is generated at step 432 by one of the front-end processors 21 using the previously described channel tuning, A/D conversion, demodulation, FEC decoding, and de-multiplexing functions.

At step 434, server apparatus 20 generates analog baseband signals from the digital transport stream generated at step 432. According to an exemplary embodiment, the analog baseband signals are generated at step 434 by A/V processor 28 using the previously described MPEG decoding, NTSC or other encoding, and D/A conversion functions.

At step 436, server apparatus 20 modulates the analog baseband signals generated at step 434 to thereby generate the first analog signals. According to an exemplary embodiment, multi-channel modulator 29 modulates the analog baseband signals at step 436 to one of the available frequency bands on the coaxial cable detected at step 420 responsive to one or more control signals provided from controller 35.

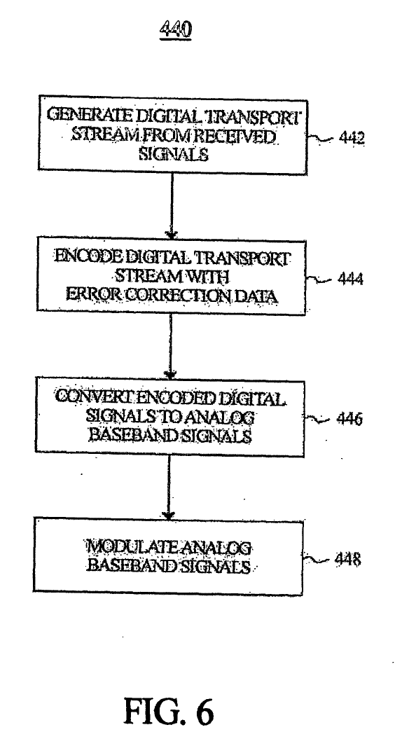

Referring back to FIG. 4, at step 440, server apparatus 20 generates second analog signals. Further details regarding step 440 of FIG. 4 according to an exemplary embodiment of the present invention are provided in FIG. 6. The details of FIG. 6 are merely exemplary, and are not intended to limit the present invention in any manner. As indicated in FIG. 6, step 440 of FIG. 4 includes sub-steps 442, 444, 446 and 448.

At step 442, server apparatus 20 generates a digital transport stream from the received broadcast signals. According to an exemplary embodiment, the digital transport stream is generated at step 442 by one of the front-end processors 21 using the previously described channel tuning, A/D conversion, demodulation, FEC decoding, and de-multiplexing functions.

At step 444, server apparatus 20 encodes the digital transport stream generated at step 442 with error correction data to thereby generate encoded digital signals. According to an exemplary embodiment, FEC encoder 31 encodes the digital transport stream at step 444 by performing R-S FEC, data interleaving, Viterbi and/or other functions.

At step 446, server apparatus 20 converts the encoded digital signals generated at step 444 to analog baseband signals. According to an exemplary embodiment, dual DAC 32 generates the analog baseband signals as separate I (i.e., in-phase) and Q (i.e., quadrature) signals.

At step 448, server apparatus 20 modulates the analog baseband signals generated at step 446 to thereby generate the second analog signals. According to an exemplary embodiment, I-Q modulator 33 modulates the analog baseband signals at step 448 to one of the available frequency bands on the coaxial cable detected at step 420 responsive to one or more control signals provided from controller 35.

Referring back to FIG. 4, at step 450, server apparatus 20 provides the first analog signals generated at step 430 to first client device 50 using one of the available frequency bands detected on the coaxial cable at step 420. Similarly, at step 460, server apparatus 20 provides the second analog signals generated at step 440 to one of the second client devices 60 using one of the available frequency bands detected on the coaxial cable at step 420. The frequency bands used at steps 450 and 460 may be the same frequency band in which case the first and second analog signals may be sent over the coaxial cable during different time intervals. Alternatively, the frequency bands used at steps 450 and 460 may be different frequency bands in which case the first and second analog signals may be sent over the coaxial cable simultaneously, or substantially simultaneously. Moreover, the steps of FIGS. 4 to 6 may be performed a plurality of times in a simultaneous manner to thereby simultaneously provide the first and second analog signals to “N” different first and second client devices 50 and 60. In this manner, server apparatus 20 may for example distribute “N” different broadcast programs to “N” different first and second client devices 50 and 60 in a simultaneous manner.

As described herein, the present invention provides an apparatus and method capable of distributing audio, video, and/or data signals in a household using the existing coaxial cable infrastructure. The present invention may be applicable to various apparatuses, either with or without a display device. Accordingly, the phrase “television signal receiver” as used herein may refer to systems or apparatuses including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A server apparatus, comprising:
receiving means for receiving broadcast signals;
first processing means for generating first analog signals responsive to said received signals;
second processing means for generating second analog signals responsive to said received signal, wherein the first analog signals have a different encoding than the second analog signals, and said first analog signals are provided to a first client device via a transmission medium connecting said server apparatus and said first client device in response to a first request signal requesting a first desired processed analog signal by identifying a first program and further wherein said second analog signals are provided to a second client device via said transmission medium connecting said server apparatus and said second client device in response to a second request signal requesting a second desired processed analog signal by identifying a second program; and
control means for detecting available frequency bands on said transmission medium, wherein said available frequency bands are used to provide said first analog signals to said first client device and to provide said second analog signals to said second client device (60), thereby causing said transmission medium to be shared between said processed analog signals and cable broadcast signals distributed over said transmission medium.

2. The server apparatus of claim 1, wherein said transmission medium includes RG-59 cable.

3. The server apparatus of claim 1, wherein said broadcast source includes a satellite source.

4. The server apparatus of claim 1, wherein said broadcast source includes a digital terrestrial source.

5. The server apparatus of claim 1, wherein said receiving means processes said received signals to generate a digital transport stream.

6. The server apparatus of claim 5, wherein said first processing means includes:
A/V processing means for processing said digital transport stream to generate analog baseband signals; and
modulating means for modulating said analog baseband signals to generate said first analog signals.

7. The server apparatus of claim 5, wherein said second processing means includes:
encoding means for encoding said digital transport stream to generate encoded digital signals;
digital-to-analog converting means for converting said encoded digital signals to analog baseband signals; and
modulating means for modulating said analog baseband signals to generate said second analog signals.

8. The server apparatus of claim 1, wherein said control means scans a plurality of frequency bands on said transmission medium to detect said available frequency bands.

9. The server apparatus of claim 1, wherein said control means detects said available frequency bands based on a user input which selects said available frequency bands.

10. A method for distributing signals from a server apparatus to a first client device and a second client device, comprising steps of:
receiving signals from a broadcast source;
generating first analog signals responsive to said received signals;
generating second analog signals responsive to said received signals, wherein the first analog signals have a different encoding than the second analog signals;
detecting an available frequency band on said transmission medium, wherein said available frequency band is used to provide said first analog signals to said first client device;
providing said first analog signals to said first client device via a transmission medium connecting said server apparatus and said first client device in response to a first request signal requesting a first desired analog signal by identifying a first program;
detecting an available frequency band on said transmission medium, wherein said available frequency band is used to provide said second analog signals to said second client device; and
providing said second analog signals to said second client device via said transmission medium connecting said server apparatus and said second client device in response to a second request signal requesting a second desired analog signal by identifying a second program, thereby causing said transmission medium to be shared between said analog signals and cable broadcast signals distributed over said transmission medium.

11. The method of claim 10, wherein said transmission medium includes RG-59 cable.

12. The method of claim 10, wherein said broadcast source includes a satellite source.

13. The method of claim 10, wherein said broadcast source includes a digital terrestrial source.

14. The method of claim 10, wherein said step of generating said first analog signals includes:
processing said received signals to generate a digital transport stream;
processing said digital transport stream to generate analog baseband signals; and
modulating said analog baseband signals to generate said first analog signals.

15. The method of claim 10, wherein said step of generating said second analog signals includes the steps of:
processing said received signals to generate a digital transport stream;
encoding said digital transport stream to generate encoded digital signals converting said encoded digital signals to analog baseband signals; and
modulating said analog baseband signals to generate said second analog signals.

16. The method of claim 10, wherein said detecting step includes scanning a plurality of frequency bands on said transmission medium to identify said available frequency band.

17. The method of claim 10, wherein said detecting step is performed based on a user input which selects said available frequency band.

18. The method of claim 10, wherein said detecting step includes scanning a plurality of frequency bands on said transmission medium to identify said available frequency band.

19. The method of claim 10, wherein said detecting step is performed based on a user input which selects said available frequency band.

20. A server apparatus, comprising:
a receiving element operative to receive broadcast signals;
first processing elements operative to generate first analog signals responsive to said received signals;
second processing elements operative to generate second analog signals responsive to said received signals, wherein the first analog signals have a different encoding than the second analog signals; and
a controller operative to detect available frequency bands on said transmission medium, wherein said first analog signals are provided to a first client device via a transmission medium connecting said server apparatus in response to a first request signal requesting a first desired analog signal by identifying a first program and said first client device and further wherein said second analog signals are provided to a second client device via said transmission medium connecting said server apparatus and said second client device in response to a second request signal requesting a second desired analog signal by identifying a second program, and further wherein said available frequency bands are used to provide said first analog signals to said first client device and to provide said second analog signals to said second client device.

21. The server apparatus of claim 20, wherein said transmission medium includes RG-59 cable.

22. The server apparatus of claim 20, wherein said broadcast source includes a satellite source.

23. The server apparatus of claim 20, wherein said broadcast source includes a digital terrestrial source.

24. The server apparatus of claim 20, wherein said receiving element is further operative to process said received signals to generate a digital transport stream.

25. The server apparatus of claim 24, wherein said first processing elements include:
an A/V processor operative to process said digital transport stream to generate analog baseband signals; and
a modulator operative to modulate said analog baseband signals to generate said first analog signals.

26. The server apparatus of claim 24, wherein said second processing elements include:
an encoder operative to encode said digital transport stream to generate encoded digital signals;
a digital-to-analog converter operative to convert said encoded digital signals to analog baseband signals; and
a modulator operative to modulate said analog baseband signals to generate said second analog signals.

27. The server apparatus of claim 20, wherein said controller scans a plurality of frequency bands on said transmission medium to detect said available frequency bands.

28. The server apparatus of claim 20, wherein said controller detects said available frequency bands based on a user input which selects said available frequency bands.
